(19) United States
(12) Patent Application Publication
(10) Pub. No.: US 2009/0137232 A1
(43) Pub. Date: May 28, 2009

(54) METHOD AND A SYSTEM FOR PROVIDING INFORMATION FROM A CUSTOMER'S BANK ACCOUNT TO HIS MOBILE PHONE

(75) Inventor: Lars Sigve Bilstad, Stabekk (NO)

Correspondence Address: FOLEY AND LARDNER LLP;SUITE 500, 3000 K STREET NW, WASHINGTON, DC, 20007, US

(73) Assignee: mobileAxept AS

(21) Appl. No.: 11/718,531

(22) PCT Filed: Nov. 3, 2004
(86) PCT No.: PCT/NO2004/000332

§ 371 Date: Sep. 24, 2007

(51) Int. Cl. H04W 4/00

(52) U.S. Cl. 455/414.3

(57) ABSTRACT

A method and system for providing information to telecommunications devices, comprising access to a receiver device (100) capable of receiving incoming calls requests from a telecommunications network (50) with at least one calling telecommunications device (10) capable of issuing call requests, said receiver device reading incoming information from the incoming call, sending a response back to a receiving telecommunications device, said response being tailored based on said incoming information.

A method and a system for providing information from a customer's bank account to his mobile phone. The present invention relates to a method and a system that is providing the bank customer with information about status on own bank accounts, by use of a mobile phone.

Bank customers being in a purchase situation, being in a public place, or driving, needs a simple and quick account information service. A mobile phone seems to be the best way of accessing such information, as it is there and it is personal.

Three separate areas of investigation led to the invention of this technology. The need and market demand was studied: a group of 20 year old students equipped with mobile phones, were observed while they were discussing, in-conclusively, who had enough money available in their bank account to buy a six pack of beer. The use of mobile phones for bank services was studied on current mobile banking usage. A mainly Internet based bank, informed the inventor that only 3% of its technology experienced customers were able to use current banking services available by mobile phones. Finally the reason why mobile phones are not used much today was studied by studying published documentation on man/machine interfaces, which showed that the current used information technology (IT) code structures often have long string formats like “8002400062421006496#5632#” (bank account number plus PIN code) and therefore are too complex to remember by heart. Users therefore often write down and keep such codes, which obviously constitutes a safety risk.

Mobile messages which are not delivered at a time convent to the user are regarded as interference in personal sphere.

Account information services are typically based on a complex code structure in order to identify the user, and for querying bank databases. There is no escape from such Information Technology (IT) codes.

U.S. Pat. No. 6,493,430 describes one example of a known method for a SMS based communication between a client and his service provider, substantially as described above.

The method and the system according to the present invention avoid the above disadvantages connected with known methods and system, as defined by the features stated in the patent claims.

The drawing discloses in

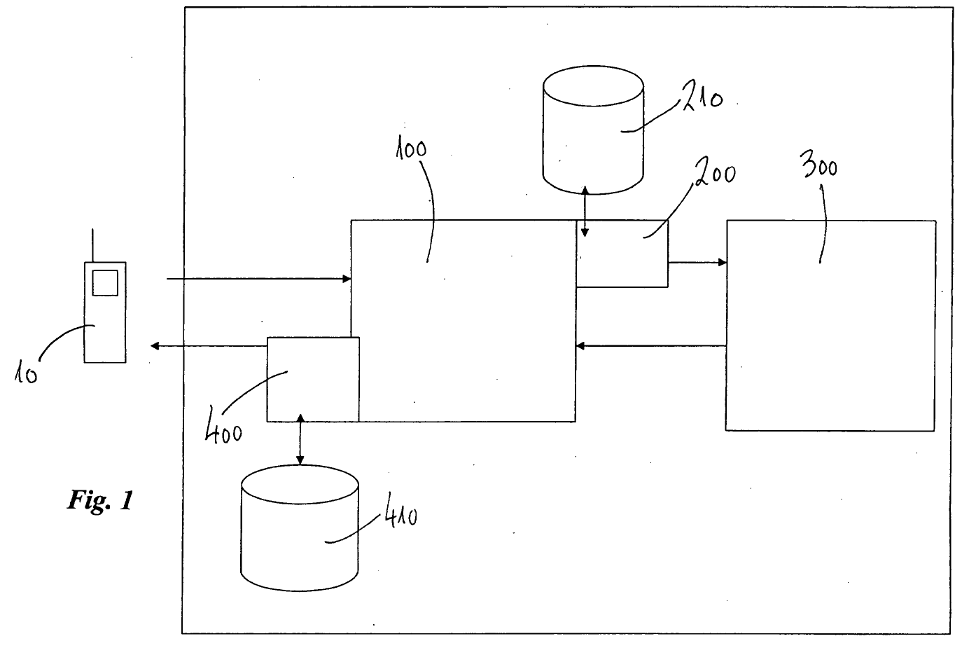

FIG. 1 a block diagram on a general example embodiment of the invention, and

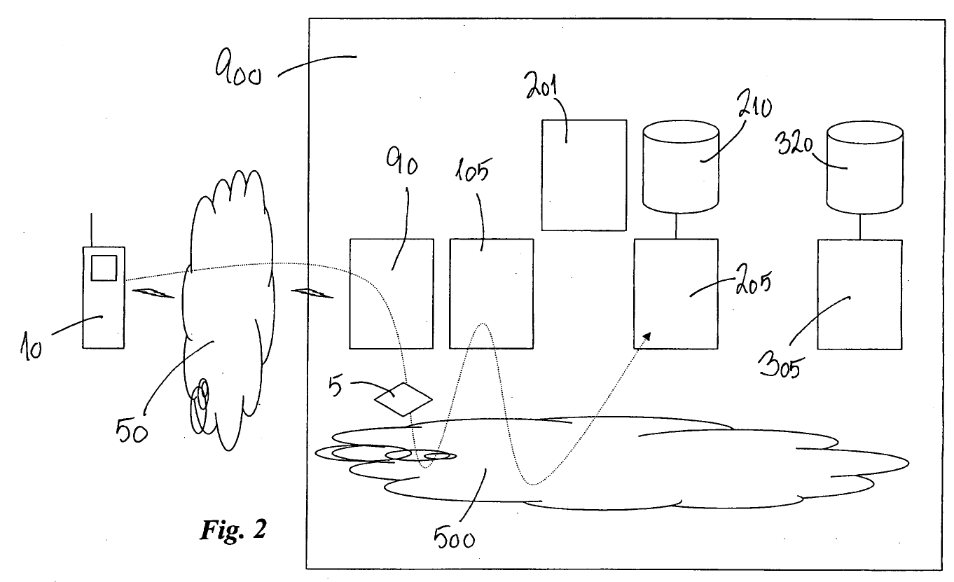

FIG. 2 discloses a block diagram on an example embodiment in the banking field.

This invention describes a method and system to handle these, for users far too complex exchange of codes, and empower users with an easy way to activate this useful system.

The invention, at the same time, cuts some cost elements. Using the invention, it is not required to use of a chargeable Telco service. This is another major differentiator to all known solutions where account information is delivered to mobile bank customer at their own time of convenience. These were the unsolved tasks that led to this invention.

In the following six known ways to provide account information to a customer are listed. However, they all have drawbacks in the man/machine interface area, and their shortcoming is already indicated by the above mentioned only 3% market penetration for the banking services employing mobile phones.

1) The banks' traditional (manually handled) customer service. The codes used today are as indicated above, that is long code strings, which the user must remember or write down. This string of sensitive data has to be spoken clear and loud to the person in the bank, in a public area or a noisy environment. Besides, the service is labour-intensive and therefore expensive for the bank.

2) Telephone keypad operated automatic remote banking services: An Interactive Voice Response (IVR) system connected to an access number asks the customer to enter long string for the account number and pin code, using the keypad. Same drawback as above to keep the code string and dial it on the keypad, some times in a preoccupied situation.

3) The voice operated automatic remote banking service, using a voice recognizing unit. The same long code must be remembered and spoken clearly and loudly, often while being in a public area or in a noisy environment.

4) The SMS (Short Message Service) initiated service, where the code string for the banking service needs to be keyed into a SMS message. The same long code string has to be remembered or written down. Operating the phone keyboard is often difficult or disturbing in situations like driving a car or during purchasing.

5) The SMS transfer or push services where changes in the available cash amount are transferred from the bank to the customer's mobile phone. For these services to work the customer cannot disable the service when receiving the SMS message is inconvenient, e.g. while in a meeting or during an evening nap.

6) Some mobile phones have software facilities to store access codes which can aid the users of some of the techniques mentioned above, e.g. by providing a one-button “available amount service”. There is however no de facto—or regulated—standards for such mobile phone applications. A bank using this approach must in fact develop a number of different phone software solutions and corresponding user manuals for the fast moving handset market.

Based upon the outlines above, the aim of the present invention is to overcome the drawbacks and limitations of the prior art, by offering easy, inexpensive and secure ways for a customer to get access to data, such as available amounts on his/her bank accounts, by the use of a modern mobile phone. This is obtained by the system and a method to be described below, for which the main features are recited in the accompanying patent claims.

All known solutions have, as we see, major problems in the area of man-machine interface. A typical problem is that the end user must remember complicated numbers, codes or sequences, different from, and in addition to telephone access numbers or Internet addresses, service and/or authentication codes. Another problem with existing systems is that a service request typically will be a charge service by the telecommunications service provider, e.g. a telephone company.

The failure of these known solutions is e.g. confirmed by the current 3% market penetration for only mobile banking services via mobile phones.

Accordingly, an object of the invention is to provide a method, system, and computer readable medium for providing users of telecommunications equipment with information.

Another object of the invention is to provide a method, system, and computer readable medium for providing users of telecommunications equipment with information more easily.

Another object of the invention is to provide a method, system, and computer readable medium for providing users of telecommunications equipment with information presented according to the equipment they use.

Another object of the invention is to provide a method, system, and computer readable medium for providing users of telecommunications equipment with information in a less costly manner.

Another object of the invention is to provide a method, system, and computer readable medium for allowing service suppliers to supply their customers information in a cost effective manner.

The above and other objects are achieved according to the present invention by providing a novel method, system, and computer readable medium in which end users who need access to a service use a telecommunications device 10, such as a mobile phone or a handheld computer, to access a predefined telecommunications address, such as a telephone number. This is sometimes called to issue a call request. The system 900 will receive the call request and read the accompanying information, without necessarily accepting the call request. Using the read accompanying information, the system will create a response which is tailored to the end user and/or the end user telecommunications device, and which provides the end user with the desired service.

If the system requires authentication, the read accompanying information will be used to authenticate the request by an optional authentication system 200 with an optional authentication database 210, without the user having to further remember, say, or key in authenticating information, such as a password.

Typically, but not necessarily, the system providing the actual user service 300 (hereafter also the called service provider system or SPS), e.g. a bank's computer system, is different from the system receiving the call request 100 (hereafter also called the call handling system or CHS). If the service provider system requires that the user authenticate himself, this may typically, but not always, be handled by the CHS. Typically, the CHS will match a caller identification part of the accompanying information in the incoming call request with a service password and service user name and send these as a part of a service request to the SPS. The SPS will authenticate the request and respond as appropriate, either directly to the end user, or to the CHS which in turn will respond to the user. One advantage with responding via the CHS is that the CHS can then tailor also the presentation of the response to the user's telecom equipment 10, e.g. screen size, color ability, etc., e.g. through an optional device capabilities system 400 with an associated optional device capabilities database 410, without any changes to the SPS 300. Optionally, the response may be sent by the SPS 300 to a third party previously identified in addition to or instead of the end user, either via the CHS 100 or directly to the previously defined third party.

Optionally, the response may contain an option for the user to initiate further actions.

In a preferred embodiment set up to provide bank customers easy and cost-effective access to account information, the invention is implemented in a system consisting of the following elements: network service trigger 5, computer telephony integration server (CTI) 101, voice response server 201, operator server 205, operator server database 210, distribution server 90, data network 500, public telephone network 50, bank server 305, bank server database 310 and a mobile unit 10.

The system contains a Public Network service trigger, based on the User Device Identifier (UDI) transferred in the call setup request. The service trigger is a result of the end user requesting the service by calling an access number, e.g. from a mobile phone.

The connect request package does not require a call setup in order to trigger the service. By using data available in a connect request signal, in-band signal through keypad or voice is not required. This service trigger will normally use signaling elements that do not result in chargeable network usage.

The CTI server is connected to a communication network, using a signaling protocol that contains a User Device Identity (UDI). Normally the UDI is the Calling Line Identifier (CLI). The CTI server contains a service trigger. The CTI server is connected to the Operator Server, and the database on the Operator Server. The CTI servers service trigger (data-program) listens for a call setup request. The CTI server takes the CLI from the connect request package and checks this identifier against valid CLI's in the Operator Server database. The CTI server gets either status UDI known, or UDI unknown from the Operator Server. If UDI is reported known from the Operator Server the CTI sends a “Clear” message to the Network.

If the User Equipment Indent is missing from the call setup request, or is reported unknown from the Operator Server, the system will attempt to set up a new user account. In this case, the CTI Server sends “Connect” to the incoming call and routes the call to a Voice Response Server (VRS).

The Voice Response Server handling all calls requesting service, where User Device Identifier is reported missing or unknown from the Operator Server, to the CTI Server. The Voice Response Server reads a message that explains the service to the end user if UDI is unknown or missing, and allows the user to type inn her UDI, normally the CLI, using the phone keypad.

As an alternative to using the phone keypad, the VRS can offer a Cell Centre agent service. The call centre agent types in the UDI in a graphical user interface.

The VRS sends clear to the end user's call, after the end user, or agent have typed manually the UDI. This manually typed UDI is transferred to the Operator Server as a service trigger. The Operator Server consists of computing resources running the Operator Server software, the Operator Server Database, network connectivity, and Transaction logs. The Operator Server is connected to the Voice Response Server, Computer Telephony Integration server, the Bank Server, and the Distribution Server, using the Data Network. The Operator Server receives through the Data Network the encrypted Customer Identifier from the Bank Server, the User Device Identifier assigned, and the sign-on pin code. This is the new or altered customer message.

The Operator Server stores the encrypted Customer Identifier from the Bank Server, the User Device Identifier assigned, and the sign-on pin code in the Operator Server Database. The Operator Server sends the Sign-on verification message containing a text, and the UDI to the Distribution Server. The Operator Server receives a Sign-on Confirmed Message from the Distribution Server. The Sign-On Confirmed message consists of the Sign-On Pin Code typed in by the user on the device keypad, the User Device Type description if present from the network and the UDI.

Upon receiving Sign-On Confirmed message, the Operator Server initiate a process that compare the sign-on Pin-Code stored in the Operator Servers database with the Sign-On Pin Code received from the Distribution Server, and if match a Data Base flag is set to mark successful sign-on process.

In case of no match on Sign-On Pin Code from Mobile Device keypad with the sign-on pin code received from sign-on form on Bank Server, The Operator server initiate a process that sets status Failed Once as flag in Operator Server Database. The Operator Server then sends the Sign-on verification message containing a text, and the UDI to the Distribution Server for a second time, using Data Network

The Operator Server receives a Sign-on Confirmed Message from the Distribution Server. The Sign-On Confirmed message consists of the Sign-On pin code typed in by the user on the device keypad, the User Device Type description if present from the network and the UDI.

Upon receiving Sign-On Confirmed message, the Operator Server checks the sign-on pin code stored in the Operator Servers database with the Sign-On Pin Code received from the Distribution Server. If no match on sign-on pin code from keypad with the sign-on pin code received from sign-on form on Bank Server, and flag Failed Once is set in Operator Server Database, the Operator Server Operator Server sends a Sign-on failed message to the Bank Server, using Data Network, containing the encrypted customer Identifier assigned to the UDI, a timestamp, and the flag Failed sign-on process.

When the flag successful sign-on is set in the Operator Server Database, the Operator Server sends a Sign-on Confirmed message to the Bank Server, using the Data Network, containing the encrypted customer Identifier assigned to the UDI, a timestamp, and the flag successful sign-on process. This completes the attempt to set up the new user account.

The Operator Server receives the service trigger (5), and its associated information, the User Device Identifier, from the CTI server or the VRS, depending on whether the UDI was known or not. The Operator Server matches the User Device Identifier with the data in the Operator Server's database. The Operator Server returns one of the two statuses based on the database lookup a) known or b) unknown to CTI Server.

If the Operator Server gets status b) unknown, back from the Operator Server database, when being requested service from the VRS, the service request is rejected. Upon status a) known User Device Identifier, the Operator Server does a lookup in the Operator Server database, using the User Device Identifier. The lookup finds the encrypted User Identifier associated with the UDI, and if present also the User Device Type (UDT).

The Operator Server sends the encrypted Customer Identifier, and if present the User Device Type to the Bank Server. This request from the Operator Server is the service trigger for the Bank Server's functionality. The Operator Server receives a Service Reply from the Bank Server. The message is received from the Bank Server on the highest level of communication available for the specific user equipment.

The Service Reply contains Charging Information, The Information Package, e.g. available amount, and the encrypted Customer Identifier. The Service Reply from the Bank Server results in a database lookup in the Operator Server's Data Base, and this lookup returns the User Device Identifier assigned to the encrypted User Identifier.

As an extra security option, the Operator Server may add a Message Checksum to the Information Package e.g. using the Information Package, UDI, and Time-Date. The reverse algorithm is applied on the User Device (10) in order to avoid undetected tampering with the Information package.

The Operator Server sends the Distribution Message to the Distribution Server. The Distribution Message contains Charging Information, Message Checksum, Information Package optionally with a checksum, and User Device identifier. UDI is normally the Calling Line Identifier (CLI).

The Distribution Server delivers connectivity between the Operator Server and several networks that service User Devices, normally mobile telephony networks. The Distribution Server provide a message charging service according to the Charging Information element, normally premium SMS.

The system servers are normally using a local area or wide area data network for data transport. The Data Network is used to connect the GUI to the Bank Server. There might be applications where more than one of the inventions server's, or the GUI, resides on the same computing structure. No data network is then required.

The Public Mobile Network transports the mobile messages, the network service trigger, and in-band signaling, as voice and Keypad information.

The Bank Server consists of computing resources running the Bank Server software, the general bank authentication module, the encryption module, the Bank Server Database, network connectivity, and transaction logs. The Bank Server is connected to the Operator Server, using the Data Network. The user connects to the Bank Server using a public data or telephony network. The Bank Server contains a bank user authentication application, and a user interface to the authentication application. Normally a WEB interface, or other Graphical User Interface (GUI).

The Operator Server sends the Bank Server a service trigger to initiate the Bank Server's operations in this process. This trigger normally contains the encrypted Customer Identifier, and if present the User Device Type to the Bank Server. The Bank Server's Encryption Module decrypts the encrypted Customer Identifier, and thereby it recreates the Username or User number accepted by the Bank Server.

Upon received service trigger from Operator Server, the Bank Server queries the Bank Server's Data Base for the relevant information e.g. available amount.

The Bank server Encryption Module encrypts the Customer Identifier. The Bank Server sends to The Operator Server a Service Reply message, basically containing the Information Package, using the Data Network. The message typically is sent from the Bank Server on the highest level of communication available for the specific user equipment if UDT was present in the service trigger.

The Service Reply from Bank Server contains Charging Information, The Information Package exemplified by Available amount, and the encrypted Customer Identifier.

The user will normally activate the service through the bank's normal web interface, and the banks' system will communicate the authentication information, normally the UDI and the encrypted customer ID and pin code, to the Operator Server which will store this information in the Operator Server Database, as will be readily apparent to those skilled in the art.

The Mobile Unit can send a service trigger as connect request to the CTI server's access number. S-n(number) and U-n(number) refer to main processes shown in figures. S-n.n refers to sub processes within the main process S-n shown in figure.

The solution provided by the system is conveniently divided into two service parts, namely a first part the new customer sign-on (Sign-On), and for updating data related to existing customers and a second part for usage (Usage) by registered users.

The new customer Sign-On process is normally performed by the user through the bank's normal web site, as will be readily apparent to those skilled in the art. At the end of this process, the Operator Server and the Bank Server have ensured the connection between the User Device Identifier and the Bank username/user number, and the servers have stored the data in their Data Bases, in order to serve the Usage process. As stated above, the system includes at least one computer readable medium, or alternatively, the computer readable medium may be accessed through various paths, such as networks, internet, drives, etc. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 200 and for enabling the computer 200 to interact with a human user. Such software may include, but is not limited to, device drivers, operating systems and user applications, such as development tools. Such computer readable media further includes the computer program product of the present invention for performing any of the processes according to the present invention, described above (see, e.g., FIG. 1-2). The computer code devices of the present invention can be any interpreted or executable code mechanism, including but not limited to scripts, interpreters, dynamic link libraries, Java classes, and complete executable programs, etc.

The invention may also be implemented by the preparation of application specific integrated circuits or by interconnecting an appropriate network of conventional component circuits, as will be readily apparent to those skilled in the art.

Information access and provision, according to this invention, is a significant simplification, in terms of implementation and use, relative to existing systems, and requires little or no training on the part of the user, as the desired information is accessed with a minimal of operations and “keystrokes” on the telecommunications terminal. In addition, a system according to the present invention, can be implemented and created utilizing most existing programming languages and be connected to most modern telecommunications devices. Therefore, according to the present invention, the process for a user to access targeted information, and the service provider to provide the same is significantly simplified, since this may now be performed directly from the telecommunications device with a minimum of operations and cost.

Although the present invention is described in terms of providing banking data to bank customers, the present invention is applicable also to a several types of other uses and users, as will be readily apparent to those skilled in the art.

Although the present invention is described in terms of providing information on a mobile phone, the present invention is applicable to all kinds of terminals which provide self-identification over a network, as will be readily apparent to those skilled in the art.

Obviously, numerous modifications and variations of the present invention are possible in light of the above teachings. It is therefore to be understood that within the scope of the appended claims, the invention may be practiced otherwise than as specifically described herein.

1-25. (canceled)

26. Method for providing information to telecommunications devices, comprising access to a receiver device (100) capable of receiving incoming call setup requests from a telecommunications network (50) with at least one calling telecommunications device (10) capable of issuing call setup requests, said receiver device reading incoming information and matching a caller identification part of the incoming information in the incoming call request with a service password and providing these as part of a service request to a service provider system (300), and sending a response back to a receiving telecommunications device, said response being tailored based on a combination of said service request and the capabilities of said telecommunications device (10).

27. Method according to claim 26, wherein said incoming information contains a unique identification of said calling telecommunications device.

28. Method according to claim 26, comprising authentication of the said call request by using the accompanying information in an authentication system (200) without further input of e.g. a password from a user.

29. Method according to claim 26, wherein said response is made to depend on an authentication of a user based on said call request, and wherein the response further is made to depend on a capability of the telecommunications device (10), said capability being defined in and provided by a device capabilities system (400).

30. Method according to claim 26, comprising also a sign-on process for set-up of a new user account wherein a sign-on password has been transferred to an operator server (205) from a user service system (300) and at a later time a password entered via the telecommunications device (10) is subsequently transferred to the operator server (205) and compared with the previously stored sign-on password.

31. Method according to claim 30, wherein a computer telephony integration server (CTI) checks a Calling Line Identifier (CLI) against valid CLI's in the operator server database.

32. Method according to claim 26, wherein a computer telephony integration server (CTI-server) (105) sends a service trigger including a user device identifier (UDI) to an operator server (205), upon which the operator server (205) compares the received UDI with data in the operator server (205), and dependent on recognizing a known UDI, the operator server finds an encrypted User identifier associated with the UDI, and sends the encrypted user identifier to a user service system (300).

33. Method according to claim 26, wherein a service is accessed via the telecommunications device (10) by use of a predefined telecommunications address, such as a telephone number, and wherein read accompanying information from the call request is used by the system to provide a response to the telecommunications device, whereby said response provides a desired service to the telecommunications device (10), the service thus being related to said predefined telecommunications address.

34. Method according to claim 26, further comprising the step of sending a server request to a server system (300), said server request containing authorization information which is not contained in said incoming information, and upon receipt of proper authorization information, said server system providing information related to said response.

35. Method according to claim 26, wherein said authorization information being associated with information contained in said incoming information.

36. Method according to claim 26, wherein the receiver device is a computer telephone integration server (CTI) (105).

37. Method according to claim 26, further comprising the step of initiating a process of setting up a new user account, based on a missing or unknown user device identification (UDI) in said call setup request.

38. Method according to claim 26, wherein said receiver device is able to read said incoming information from said incoming call request without accepting said incoming call request.

39. Method according to claim 26, wherein said receiving device is further connected to an operator server (205) comprising an operator server database (210).

40. Method according to claim 26, wherein the receiving telecommunications device is the same as the calling telecommunications device (10).

41. Method according claim 26, wherein a user device identification (UDI) contains information related to the capabilities of the display of the receiving telecommunications device, or information about said telecommunications device from which said capabilities can be concluded.

42. Method according to claim 26, wherein said tailoring at least includes providing said response in a format suitable to said receiving device.

43. Method according to claim 26, wherein said response includes option for the user for further action.

44. Method according to claim 26, in which a service provider system is integrated with the receiving device.

45. Method according to claim 26, in which the authorization information is previously accepted by the end user.

46. Method according to claim 26, wherein said further action includes sending a response back to the owner of said calling telecommunications device.

47. A system configured to perform the steps recited in claim 26.

48. A computer readable media, including program instructions executing on a computer, the computer readable media including instructions for performing the method according to claim 26.

49. Computer network data signals, the computer data signals carrying information for practicing the method of claim 26.

50. Method according for accessing a service via a telecommunications device (10) by use of a predefined telecommunications address, such as a telephone number, wherein accompanying information read from a call request is used by a service system (300) to provide a response to the telecommunications device (10), whereby said response provides a desired service to the telecommunications device (10), the service thus being related to said predefined telecommunications address.

51. A system configured to perform the steps recited in claim 50.

52. A computer readable media, including program instructions executing on a computer, the computer readable media including instructions for performing the method according to claim 50.

53. Computer network data signals, the computer data signals carrying information for practicing the method claim 50.
